(19) United States
(12) Patent Application Publication
(10) Pub. No.: US 2004/0265561 A1
(43) Pub. Date: Dec. 30, 2004

(54) Plastic foam products consisting of beads

(76) Inventor: Jurgen Bruning, Ohrdruf (DE)

Correspondence Address: Nils H Ljungman, Nils J Ljungman & Associates, P O Box 130, Greenburg, PA, 15601-0130, US

(21) Appl. No.: 10/474,151

(22) PCT Filed: Mar. 16, 2001
(86) PCT No.: PCT/EP01/03048

(30) Foreign Application Priority Data
Apr. 4, 2000 (DE) 100 16 671.7

(51) Int. Cl. B32B 3/26

(52) U.S. Cl. 428/304.4

(57) ABSTRACT

According to the invention, the production of plastic foam products consisting of beads comprises the molding of pimples in an automatic molding machine. Said pimples reduce the noise that is produced when the product is subjected to friction.

The invention relates to plastic foam products comprising beads. Beads are foam particles of small dimensions. Various plastics can be employed in this context, for example, polystyrene (PS), polyethylene (PE), or polypropylene (PP). The beads can have a spherical or some other shape. The shapes of the beads are determined in part by the way in which they are produced. Irrespective of the shape, the bead diameter is generally used to define the size of the beads. Diameters of 0.5 to 6 millimeters are customary. This does not exclude smaller or larger beads. A fundamental distinction is drawn, in producing beads, between production in an autoclave and production by extrusion. After production, the beads are held in silos or in some other suitable way before being used. The beads are joined together in a mold, referred to as an automatic molding machine. This is accomplished by heating the beads at the surfaces until there is a greater or lesser degree of softening, and by compression. Given sufficient melting of the surface and sufficient pressure, the beads weld together. Adequate bonding/sintering may occur with less melting and with a lower pressure.

Heating not only causes melting of the surface but also expansion. The expansion depends on the type and amount of gas that is trapped in the beads. The expansion contributes to the build-up of pressure. Otherwise, the pressure is normally built up by virtue of the fact that the beads are fed into the mold cavity of the automatic molding machine under pressure and that the cavity is completely filled.

A gaseous medium, in particular conveying air, is suitable for feeding in the beads. Conveying air is available in abundant supply. One blower is sufficient for producing conveying air. The blower draws in ambient air and forces this air through a pipe into the mold cavity of the automatic molding machine. On the way to the mold cavity, the conveying air draws the desired quantity of beads from the bottom out of a silo.

In the mold cavity, the beads are separated from the conveying air. While the conveying air is leaving through passages in the walls, the beads are retained by the walls of the automatic molding machine.

Once sufficient filling has been achieved, the feed opening of the mold is closed. Superheated steam is then blown through corresponding nozzles into the mold cavity. The superheated steam flows between the beads to the opposite side of the mold cavity and flows out there.

The aim for plastic products is a rather smooth surface. This is generally due to reasons of aesthetics, but also due to other reasons, for example, reasons of hygiene. Smooth surfaces are more user friendly for cleaning than rough surfaces. This is of particular importance in applications in health care environments and in environments dealing with food.

A main application of plastic foam products is in motor vehicles. A number of different applications arise in the vehicle compartment, such as, in the region of the door, in the region of the instrument panel at the dash board, in the region of the top or shelf panel for a dash board, and in the region of the horizontal storage panel behind the rear seats.

Plastic foam products also find application in the trunk; similarly, they find application in the region of the bumpers.

Distracting noise is a longstanding problem with motor vehicles. This is particularly so with creaky noise. The inventor has recognized that the noises originate with the plastic foam products. The creaky noise is produced by friction between the plastic foam products and other vehicle components. The reasons for the friction are vehicle oscillations, vibrations, and twisting or torsion.

It is accordingly an object of the invention to reduce noise due to plastic foam products and to substantially eliminate such noise. In accordance with the invention this is accomplished by means of flexible protuberances at the product surface. This is based on the consideration that the plastic foam performs, upon movement in the region of contact with another article, another movement. For example, during a uniform main movement of the plastic foam body, the beads at the friction surface perform a movement comprising short jerks. This is attributed to the interaction between static friction and resilience of the plastic foam. In comparison to other materials, the plastic foam has a high resilience. At the same time, the plastic foam has considerable friction coefficients. Due to the high friction coefficients and the high resilience, individual beads are restrained until sufficiently high forces are developed at the beads which overcome the friction forces. This causes that the beads accelerate forwardly in the general direction of movement until they come to rest again at the friction surfaces. This is followed by a repeat of the deformation of the beads at the corresponding surface region.

The propensity to cause creaky noise of plastic is measured, in accordance with the invention, as a sliding force amplitude. The sliding force amplitude is defined by the difference between minimal and maximal forces that are necessary to maintain a sliding movement of constant relative velocity between a plastic foam product and a second body. The peak of the sliding force amplitude is determined by the difference between adhesive friction and sliding friction during a dynamic friction movement. As the peak of the sliding force amplitude decreases, the propensity of the material to cause creaky or other noise during friction sliding movement decreases. The frequency of oscillations, that is, the periodic change of adhesive and sliding friction, also affects the noise behavior. A low frequency is perceived to a lesser extent or not at all, whereas higher frequencies are perceived to be more disturbing.

In accordance with the invention, the resilience of the plastic foam products is increased at the surface. This is achieved by protuberances. Within the scope of the invention, the protuberances particularly are resilient raised portions at the surface of the foam products that are subjected to friction. The protuberances have a distinct, that is a longer, deformation path at the surface than other, smooth, beads. Depending on a particular situation, the movements that cause noise are fully prevented. Or much longer movements arise and the resulting air oscillations are of another, deeper, frequency. The human ear does not consider these oscillations to be disturbing.

Protuberances at the surface of the plastic foam products are also useful in reducing the propensity to cause creaky noise over a lengthier frictional strain, or to prevent this, or even to minimize the propensity to cause creaky noise. In contrast, the propensity to cause creaky noise increases for plastic foam products without protuberances in the event of lengthier frictional strain, because softening, deformation, or wear, lead to an increase of the sliding force amplitude at a surface that does not have protuberances.

Advantageously, the protuberances can be employed in friction applications similar to that of a motor vehicle.

The protuberances can be shaped as spheres, as pointed cones, and/or as truncated cones. The protuberances may be configured as hemispheres or ball-type kalottes. The base area of the protuberances can be round and/or shaped with corners. Among others, triangular or rectangular base areas are possible, as well as round or oval base areas. The dimensions are of importance for the protuberances. Preferably,

the distance between protuberances is 0.003 to 3 millimeters, preferred is 0.03 to 0.3 millimeters, and/or

the height of the protuberances is 0.001 to 1 millimeter, preferred 0.01 to 0.1 millimeter, and/or

the diameter at the base area is 0.001 to 5 millimeters, preferred is 0.01 to 0.5 millimeters.

The term diameter herein is to indicate the respectively greater diameter that can be measured at the base area of the protuberance. The incline at the mantle surface of the cone for conical protuberances with respect to the vertical can be small, or approach zero, such that the protuberances are approaching a shape that is like a strand. The inclination, however, may also be great, for example, 45 degrees and greater.

The protuberances according to the present invention are produced thereby that the cavity of the automatic molding machine is configured at the inner surface in a corresponding manner, that is, it has depressions into which the beads are pressed.

As an alternative, the invention proposes to provide a woven material in the mold cavity which woven material has mesh openings, a total thickness, or respectively thread thickness, in consideration of the desired shape of the protuberances. The beads are pressed into the mesh of the woven material. In this, the mesh width determines the base area of the protuberance, the total thickness of the textile woven material determines the height of the protuberance, and the thread thickness determines the distance of the protuberances from another. In terms of method aspects, textiles have the advantages which will be further described in the following.

In place of textiles, one can also use sheet metal, which is provided with corresponding openings, distances, and thicknesses.

It is advantageous to provide a further woven material, as a support, underneath the woven materials or underneath the sheet metal. The woven material layers provide a plurality of channels or openings, respectively, for the exit of air and superheated steam, and also for the entry of superheated steam. Preferably, the woven materials very finely divide the superheated steam. This accomplishes an extremely good stream of superheated steam through the mold cavity.

Surprisingly, the amount of condensate associated with the superheated steam at the exit side is much smaller in the case of the inventive use of woven materials, than in customary automatic molding machines. The amount of condensate otherwise impairs the quality of the products. The advantageous guiding of superheated steam also improves the cycle times. These can be shortened.

The mesh size or width of the woven material is always significantly smaller than the corresponding bead diameter, at least by 50% and preferred is 75% smaller, or even smaller still. The woven material may be a textile or a metal woven material.

Advantageous is a wire woven material of steel, particularly multi-layer wire woven material and comprising alloying components to form high-grade steel, such as, chromium, nickel, and molybdenum. It is preferred that the woven material layers are configured so as to have a mesh structure that is more coarse and/or thicker and/or provides a support or, respectively, a carrying function, when considered in the direction away from the inner wall of the mold cavity (in the lower region).

The total thickness of the woven material layer used can be affected by the required air/steam flow and/or by stability considerations. The thicker the threads/wires and the larger the mesh widths, the more easily the superheated steam can flow through. The thickness may be up to 15 millimeters, especially 3 to 5 millimeters.

The woven materials used optionally rest on a continuous wall or a wall provided with through openings, and/or the woven materials used are designed to be completely or partially self-supporting, and/or rest completely or partially on supporting surfaces of the automatic molding machine.

Selectively, the woven fabric is plate-shaped, planar, or formed. A formed configuration can be comprised of woven material segments.

The deformation of metallic woven materials can be achieved by means of a suitable press. Deformation is significantly easier if the metallic woven materials are heated.

The woven material layers are deformed individually, or jointly. The sequentially deformed woven material layers are preferably connected to one another. Advantageous is sintering of metallic woven material. Selectively, there is also possible welding or a connection by way of a heat-resistant glue.

The protuberances that are produced are subsequently selectively contacted in one process step in the automatic molding machine with superheated steam such that the surface of the protuberances slightly melts and has a lower friction coefficient.

The drawing illustrates an embodiment of the invention.

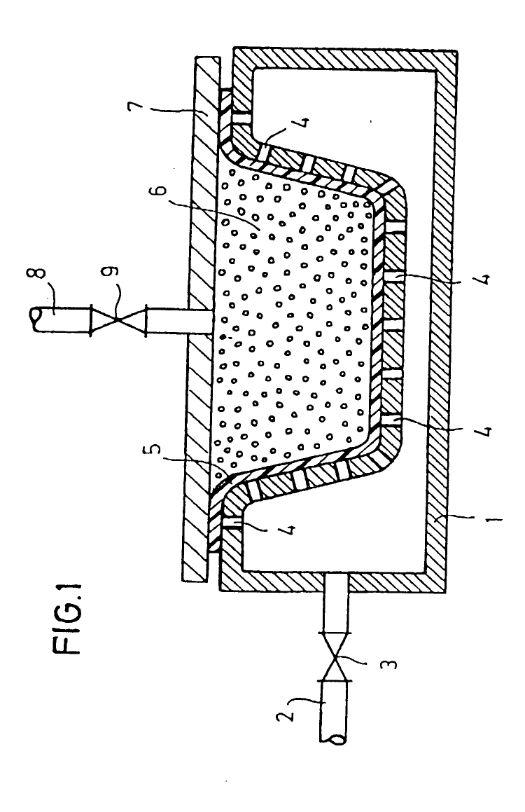

FIG. 1 shows the shape of an automatic molding machine comprising a bottom part 1 and a top part 7 with a seal 10 in between at the edge. The bottom part 1 is provided with a wire woven material layer 5.

After the mold has been closed, the mold cavity is evacuated via a line 2 by opening a valve 3. The vacuum is generated by pumping out the air.

Its place is taken by compressed air flowing in simultaneously via a line 8 owing to the opening of a valve 9. Beads are fed in with the air. The beads have a diameter of 3 millimeters and are composed of polypropylene (PP). The air pressure is 6 bar.

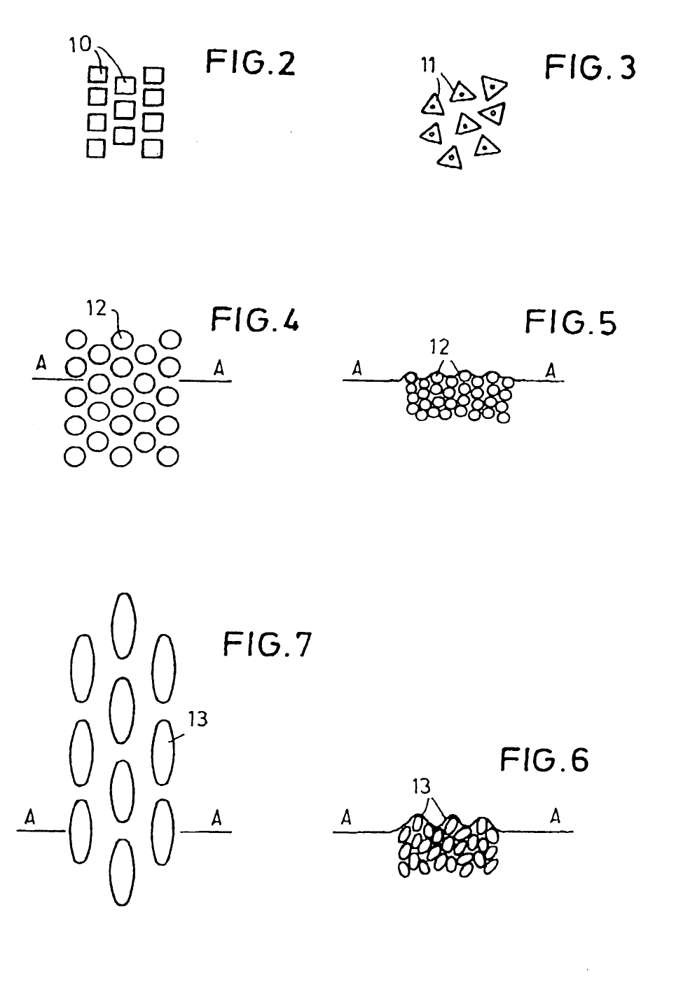

The compressed air flows through the woven material layer 5. The woven material layer 5 takes up the compressed air in an optimum manner and guides it to openings 4 in the bottom part 1. The woven material layer 5 is a two-ply structure and is made of woven wire material. Each layer has a different mesh width. The woven material layer on the bead side has a significantly smaller mesh width than the woven material layer on the same side as the bottom part. In the exemplary embodiment this is 0.2 millimeters. FIG. 2 illustrates the layer ply at the side of the beads drawn in a larger scale and in top plan view. The steel wires are disposed in superposed position with respect to one another. FIG. 3 illustrates the cross-section through the wire woven material on the side of the beads. The lower layer of the wires 11 and 12 form curves or arcs 13, such that on the bead side (apart from the contour shown in FIG. 1 of the woven material and irrespective of the mesh of the woven material) a planar surface is generated.

The contour shown in FIG. 1 results from deformation in a suitable press.

After complete filling of the mold cavity, superheated steam is forced through the line 8 into the mold cavity instead of air. The superheated steam must flow through the beads. During this process, the air is displaced between the beads. The steam heats up the beads and their surface softens.

The increase in temperature causes the beads to expand. Owing to the softened outer surface of the beads and the pressure, welding takes place at all the points of contact between the beads. The gaps between the beads are closed at the same time.

After adequate cooling following opening of the mold, the finished product 6 is removed from the mold cavity.

The product 6 has protuberances at the surface, which are produced thereby that beads are partially pressed into the mesh of the woven material. The protuberances are illustrated in plan view in FIG. 2 and they are in the mirror image of the wire mesh. The diameter of the beads is 0.2 millimeter, the distance is 0.3 millimeter, the height is 0.5 millimeter.

FIG. 3 illustrates protuberances 11 having a triangular base area. FIGS. 4 and 5 illustrate round protuberances 12, FIGS. 6 and 7 illustrate elliptical protuberances 13.

1. Plastic foam products comprising beads, particularly for motor vehicles, characterized thereby that the surface comprises formed protuberances (10, 11, 12, 13) which minimize noise due to friction.

2. Plastic foam products according to claim 1, characterized thereby that the protuberances are changed in their dimensions and changed in their spatial arrangement with respect to one another and/or the corresponding friction surfaces are changed, until the amplitude of the frictional force has reached a magnitude that corresponds to the desired minimization of noise.

3. Plastic foam products according to claim 1, characterized thereby that the protuberances are changed in their dimensions and changed in their spatial arrangement with respect to one another and/or the corresponding friction surfaces are changed, until the vibration frequency during dynamic friction movements has a magnitude that corresponds to the desired minimization of noise.

4. Plastic foam products according to claim 1, characterized by protuberances that have the following dimensions
a) height from 0.001 to 1 millimeter, preferably 0.01 to 0.1 millimeter
b) distance of separation from 0.003 to 3 millimeters, preferably 0.03 to 0.3 millimeter
c) diameter at the base from 0.001 to 5 millimeters, preferably 0.01 to 0.5 millimeter.

5. Plastic foam products according to claim 1, characterized by protuberances (10, 11, 12, 13) that are rounded and/or shaped with corners.

6. Plastic foam products according to claim 5, characterized by protuberances that have a shape like a cone, a pyramid, or a truncated cone.

7. Plastic foam products according to claim 1, characterized by a surface that has been shaped by melting.

8. Method for making the products according to claim 1, characterized by use of an automatic molding machine having a mold cavity into which cavity the beads are introduced and wherein the beads are contacted with a gaseous heat carrier, preferably superheated steam, such that the gaseous heat carrier enters the mold cavity through a surface of the automatic molding machine and leaves through another surface of the automatic molding machine, and the mold cavity has recesses which are configured to shape the protuberances to their corresponding configuration.

9. Method according to claim 8, characterized by the use of a woven material and/or sheet metal having holes, disposed at the inner surfaces of the mold cavity, such that the mesh of the woven material and/or the openings are reflected in corresponding protuberances.

10. Method according to claim 9, characterized by use of a woven material (5) made of a textile or of metal and/or wire (11, 12), and/or use is made of a woven material comprising a plurality of layers, and/or is fully or partially self-supporting, and/or fully or partially is supported at a mold cavity wall, and/or has a thickness up to 15 millimeters, preferably 3 to 5 millimeters and the mesh width is at most one half the bead diameter and/or is adapted to the shape of the mold cavity.

11. Method according to claim 10, characterized by use of a wire screen the mesh openings of which increase in the layer that is facing away from the beads, and/or in the lower region is configured as support or carrier layer, and/or is made of high-grade steel, and/or is comprised of screen layers which are connected to one another by welding, by sintering, or by gluing.

12. Method according to claim 11, characterized by carrying out a heated gas contacting of the protuberances upon removal of the products from the automatic molding machine.

13. Plastic foam products according to claim 2, characterized thereby that the protuberances are changed in their dimensions and changed in their spatial arrangement with respect to one another and/or the corresponding friction surfaces are changed, until the vibration frequency during dynamic friction movements has a magnitude that corresponds to the desired minimization of noise.

14. Plastic foam products according to claim 13, characterized by protuberances that have the following dimensions
a) height from 0.001 to 1 millimeter, preferably 0.01 to 0.1 millimeter
b) distance of separation from 0.003 to 3 millimeters, preferably 0.03 to 0.3 millimeter
c) diameter at the base from 0.001 to 5 millimeters, preferably 0.01 to 0.5 millimeter.

15. Plastic foam products according to claim 14, characterized by protuberances (10, 11, 12, 13) that are rounded and/or shaped with corners.

16. Plastic foam products according to claim 15, characterized by protuberances that have a shape like a cone, a pyramid, or a truncated cone.

17. Plastic foam products according to claim 16, characterized by a surface that has been shaped by melting.

18. A motor vehicle component, such as a door, an instrument panel at a dash board, a top or shelf panel of a dash board, a horizontal storage panel behind rear seats, a trunk, or a bumper, said motor vehicle component comprising:
a plastic foam body comprising an exterior surface;
said plastic foam body comprising protuberances being disposed to protrude from said exterior surface;
said protuberances being configured and disposed to minimize noise produced by friction caused by relative movement between said plastic foam body and a surface of said motor vehicle component in contact with said plastic foam body.

19. The motor vehicle component according to claim 18, wherein said protuberances are configured to be changed in their dimensions and configured to be changed in their spatial arrangement with respect to one another and/or the corresponding friction surfaces are configured to be changed, until the amplitude of the frictional force has reached a magnitude that corresponds to the desired minimization of noise.

20. The motor vehicle component according to claim 19, wherein the protuberances are configured to be changed in their dimensions and configured to be changed in their spatial arrangement with respect to one another and/or the corresponding friction surfaces are configured to be changed, until the vibration frequency during dynamic friction movements has a magnitude that corresponds to the desired minimization of noise.
